(19) United States
(12) Patent Application Publication
(10) Pub. No.: US 2022/0163788 A1
(43) Pub. Date: May 26, 2022

(54) OBSTACLE DETECTION APPARATUS

(71) Applicant: Mitsubishi Electric Corporation, Tokyo (JP)

(72) Inventors: Yuichiro HORIGUCHI, Chiyoda-ku, Tokyo (JP); Yoshitaka KAJIYAMA, Chiyoda-ku, Tokyo (JP); Yoko INOUE, Chiyoda-ku, Tokyo (JP); Masaharu IMAKI, Chiyoda-ku, Tokyo (JP)

(73) Assignee: Mitsubishi Electric Corporation, Tokyo (JP)

(21) Appl. No.: 17/441,301

(22) PCT Filed: Jun. 12, 2019
(86) PCT No.: PCT/JP2019/023302

§ 371 Date: Sep. 21, 2021

(51) Int. Cl. G02B 26/08; G02B 26/10; G01S 7/481

(52) U.S. Cl. CPC G02B 26/0833; G01S 7/4817; G02B 26/101

(57) ABSTRACT

The obstacle detection apparatus mainly includes an optical deflector, a first reflection mirror, a second reflection mirror, and a light receiver. The first reflection mirror is arranged to face the optical deflector. The second reflection mirror is arranged at one side of the first reflection mirror further from the optical deflector. The optical deflector scans a light beam conically about a first axis. The first reflection mirror and the second reflection mirror are driven to rotate about a second axis in synchronization with each other. The second axis is coaxial with the first axis.

### TECHNICAL FIELD

The present invention relates to an obstacle detection apparatus.

### BACKGROUND ART

Japanese Patent No. 6069628 (PTL 1) discloses a scanning type distance measuring apparatus including a laser diode, an avalanche photodiode, a first deflection mechanism facing the laser diode and the avalanche photodiode, a second deflection mechanism, and a non-contact power supply unit. The first deflecting mechanism includes a deflection mirror and a driving unit. The deflection mirror is swingable about a horizontal axis. The deflection mirror reflects a light beam emitted from the laser diode toward a surrounding space of the scanning type distance measuring apparatus, and reflects a light beam reflected by an object in the surrounding space of the scanning type distance measuring apparatus toward the avalanche photodiode. The driving unit drives the deflection mirror to swing about the horizontal axis. The second deflection mechanism rotates the first deflection mechanism about a vertical axis.

The non-contact power supply unit includes a first coil and a second coil. The second coil is electrically connected to the driving unit of the first deflection mechanism. The second coil rotates about the vertical axis in accordance with the rotation of the second deflection mechanism. The first coil shares the vertical axis with the second coil, and is arranged with a distance from the second coil. When a current flows through the first coil, an electromotive force is generated in the second coil by electromagnetic induction. The electric power may be supplied from the second coil to the driving unit of the first deflection mechanism that rotates about the vertical axis with the second coil.

### CITATION LIST

### Patent Literature

PTL 1: Japanese Patent No. 6069628

### SUMMARY OF INVENTION

### Technical Problem

However, in the scanning type distance measuring apparatus disclosed in PTL 1, since the deflection mirror not only reflects the light beam emitted from the laser diode toward the surrounding space of the scanning type distance measuring apparatus but also reflects the light beam reflected by the object in the surrounding space of the scanning type distance measuring apparatus toward the avalanche photodiode, the deflection mirror has a larger size. In order to drive the deflection mirror having a larger size, the driving unit of the first deflecting mechanism and the second deflecting mechanism must be made larger, which makes the scanning type distance measuring apparatus larger in size. An object of the present invention is to provide an obstacle detection apparatus smaller in size.

### Solution to Problem

The obstacle detection apparatus of the present invention mainly includes an optical deflector, a first reflection mirror, a second reflection mirror, and a light receiver. The optical deflector is configured to scan at least one light beam conically about a first axis. The first reflection mirror is arranged to face the optical deflector and rotatable about a second axis. The first reflection mirror is configured to reflect at least one light beam toward a surrounding space of the obstacle detection apparatus. A first mirror face of the first reflection mirror is inclined with respect to the first axis and the second axis. The second reflection mirror is arranged on a distal side from the optical deflector with respect to the first reflection mirror and rotatable about the second axis. The second reflection mirror is configured to reflect at least one light beam diffusely reflected by an object in the surrounding space of the obstacle detection apparatus toward the light receiver. A second mirror face of the second reflection mirror is inclined with respect to the second axis in a direction opposite to the first mirror face. The light receiver is configured to receive at least one light beam reflected by the second reflection mirror. The first reflection mirror and the second reflection mirror are driven to rotate about the second axis in synchronization with each other. The second axis is coaxial with the first axis.

### Advantageous Effects of Invention

Since the reflection of the light beam diffusely reflected by the object in the surrounding space of the obstacle detection apparatus toward the light receiver is performed by the second reflection mirror different from the first reflection mirror, it is possible to make the first reflection mirror smaller in size. Since the second axis is coaxial with the first axis, it is possible to make smaller the first reflection mirror which reflects the light beam scanned conically by the optical deflector about the first axis. Therefore, it is possible to make the obstacle detection apparatus of the present invention smaller in size.

### BRIEF DESCRIPTION OF DRAWINGS

FIG. 1 is a perspective view schematically illustrating an obstacle detection apparatus according to a first embodiment and a sixth embodiment with a part thereof cut away;

FIG. 2 is a cross-sectional view taken along line II-II in FIG. 1 and schematically illustrating the obstacle detection apparatus according to the first and sixth embodiments;

FIG. 3 is a cross-sectional view schematically illustrating an enlarged part of the obstacle detection apparatus according to the first and sixth embodiments;

FIG. 4 is a perspective view schematically illustrating an enlarged part of the obstacle detection apparatus according to the first and sixth embodiments;

FIG. 5 is a diagram illustrating control blocks of the obstacle detection apparatus according to the first and sixth embodiments;

FIG. 6 is a diagram schematically illustrating an optical scanning range and a detection range of the obstacle detection apparatus according to the first and sixth embodiments;

FIG. 7 is a diagram illustrating exemplar scanning points and detection points of the obstacle detection apparatus according to the first embodiment;

FIG. 8 is a diagram illustrating another exemplar scanning points and detection points of the obstacle detection apparatus according to the first embodiment;

FIG. 9 is a cross-sectional view schematically illustrating an obstacle detection apparatus according to a second embodiment;

FIG. 10 is a cross-sectional view schematically illustrating an obstacle detection apparatus according to a third embodiment;

FIG. 11 is a cross-sectional view schematically illustrating an obstacle detection apparatus according to a fourth embodiment;

FIG. 12 is a cross-sectional view schematically illustrating an obstacle detection apparatus according to a fifth embodiment; and

FIG. 13 is a diagram illustrating exemplar scanning points and detection points of an obstacle detection apparatus according to a sixth embodiment.

### DESCRIPTION OF EMBODIMENTS

Hereinafter, embodiments of the present invention will be described. The same components are denoted by the same reference numerals, and the description thereof will not be repeated.

### First Embodiment

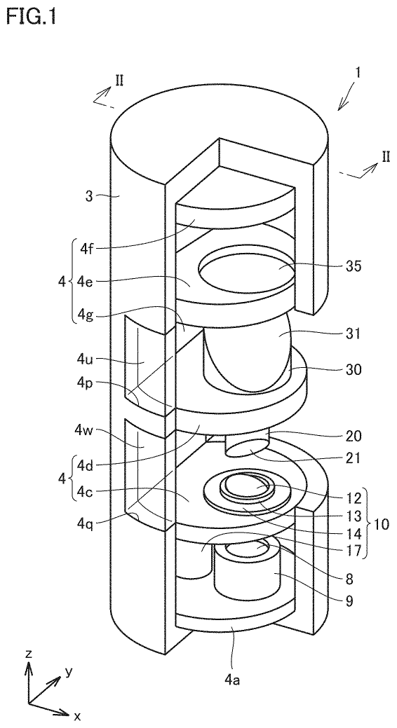

An obstacle detection apparatus 1 according to a first embodiment will be described with reference to FIGS. 1 to 5. The obstacle detection apparatus 1 mainly includes an optical deflector 10, a first reflection mirror 20, a second reflection mirror 30, and a light receiver 36. The obstacle detection apparatus 1 may further include a first driving unit 24 and a case 4. The obstacle detection apparatus 1 may further include a light source 5 and a collimator lens 8. The obstacle detection apparatus 1 may further include a condenser lens 35.

The obstacle detection apparatus 1 is, for example, a laser imaging detection and ranging (LiDAR) system. The obstacle detection apparatus 1 outputs at least one light beam 6 from the light source 5 to a surrounding space of the obstacle detection apparatus 1. When an object such as an obstacle is present in the surrounding space of the obstacle detection apparatus 1, the light beam 6 is diffusely reflected by the object. The light receiver 36 receives the light beam 6 diffusely reflected by the object. The obstacle detection apparatus 1 scans the light beam 6 in three dimensions. Thus, the three-dimensional position and shape of the object in the surrounding space of the obstacle detection apparatus 1 are obtained. The obstacle detection apparatus 1 may detect an obstacle in the surrounding space of the obstacle detection apparatus 1.

Hereinafter, the configuration of the obstacle detection apparatus 1 will be described in detail.

The light source 5 is configured to emit at least one light beam 6 toward the optical deflector 10. The light beam 6 emitted from the light source 5 may be, for example, a laser beam. The light source 5 is not particularly limited, and may be a laser light source such as a semiconductor laser. The light source 5 is supported by a bottom plate 4a of the case 4. The light source 5 may emit the light beam 6 in the +z direction (i.e., the vertical direction). The optical axis 7 of the light beam extends along the z axis (i.e., the vertical axis).

The collimator lens 8 may be arranged between the light source 5 and the optical deflector 10. The collimator lens 8 is supported by a lens holder 9. The lens holder 9 is fixed to the bottom plate 4a of the case 4. The collimator lens 8 collimates the light beam 6 and emits the collimated light beam 6 to the optical deflector 10. The light beam 6 incident on the optical deflector 10 may travel along the z axis (i.e., the vertical axis) and may have a vector i0 of (0, 0, 1).

The optical deflector 10 is configured to scan the light beam 6 conically about the first axis 11. The trajectory of the light beam 6 scanned by the optical deflector 10 forms a conical surface. The first axis 11 extends in the z direction (i.e., the vertical direction). The first axis 11 may be coaxial with the optical axis 7 of the light beam 6 incident on the optical deflector 10. The first axis 11 extends along the z axis (i.e., the vertical axis).

Specifically, the optical deflector 10 includes a wedge prism 12 and a second driving unit 17. The optical deflector 10 may further include a prism holder 13, a bearing 14, a first gear 15, a second gear 16, and a second shaft 18.

The wedge prism 12 has a top face 12a inclined with respect to the first axis 11 and a bottom face perpendicular to the first axis 11. The top face 12a of the wedge prism 12 is inclined with respect to the optical axis 7 of the light beam 6 incident on the optical deflector 10. The bottom face of the wedge prism 12 is perpendicular to the optical axis 7 of the light beam 6 incident on the optical deflector 10. The bottom face of the wedge prism 12 may face the light source 5 or the collimator lens 8.

The normal line to the top face 12a of the wedge prism 12 is inclined with respect to the first axis 11 or the optical axis 7 of the light beam 6 incident on the optical deflector 10. The top face 12a of the wedge prism 12 deflects the light beam 6. The wedge prism 12 has a deflection angle α, and the light beam 6 is deflected on the top face 12a of the wedge prism 12 by the deflection angle α with respect to the first axis 11 or the optical axis 7 of the light beam 6 incident on the optical deflector 10.

The wedge prism 12 is rotatable about the first axis 11. Specifically, the wedge prism 12 is held by the prism holder 13 having a cylindrical shape. The prism holder 13 is attached to a flat plate 4c of the case 4 via the bearing 14 in such a manner that it is rotatable about the first axis 11. Thus, the wedge prism 12 is attached to the case 4 in such a manner that it is rotatable about the first axis 11. The opening diameter of the optical deflector 10 (the wedge prism 12) is larger than the beam diameter of the light beam 6.

The second driving unit 17 is, for example, a second motor. The second driving unit 17 is attached to the flat plate 4b of the case 4. The second driving unit 17 is configured to rotate the wedge prism 12 about the first axis 11. Specifically, the first gear 15 is fixed to the outer circumference of the prism holder 13. The second gear 16 meshes with the first gear 15. The second gear 16 is coupled to the second shaft 18. The second drive unit 17 is configured to rotate the second shaft 18.

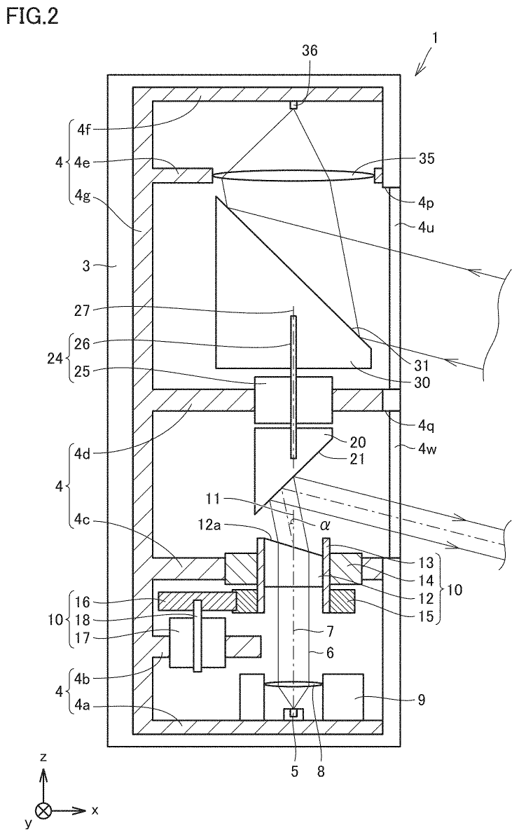

When the second shaft 18 is rotated by the second drive unit 17, the first gear 15 and the second gear 16 rotate accordingly, whereby the wedge prism 12 rotates about the first axis 11. Thus, the wedge prism 12 scans the light beam 6 conically about the first axis 11 with an apex angle 2α. The light beam 6 deflected by the wedge prism 12 has a vector i₁=(i₁ₓ, i_{1y}, i_{1z})=(cos θ sin α, sin θ sin α, cos α). As illustrated in FIG. 4, the angle θ is a rotation angle of the wedge prism 12 rotated from the front direction (+x direction) of the case 4. When the light beam 6 is deflected by the optical deflector 10 (the wedge prism 12) to the front direction (+x direction) of the case 4 with respect to the first axis 11, the angle θ is 0°. In FIG. 2, the angle θ is 180° or −180°.

The first reflection mirror 20 is arranged to face the optical deflector 10. The first reflection mirror 20 is arranged in such a manner that the light beam 6 scanned conically by the optical deflector 10 is incident on the first reflection mirror 20. The first reflection mirror 20 is configured to reflect the light beam 6 scanned conically by the optical deflector 10 toward the surrounding space of the obstacle detection apparatus 1.

Specifically, the first reflection mirror 20 may be, for example, a rod mirror. The first reflection mirror 20 may be formed by cutting a cylindrical member obliquely with respect to the axial direction of the cylindrical member so as to form an inclined end face on the cylindrical member, and coating a reflection material on the inclined end face. A first mirror face 21 of the first reflection mirror 20 may be the inclined end face coated with a reflection material. The first mirror face 21 of the first reflection mirror 20 faces the top face 12a of the wedge prism 12. The first mirror face 21 of the first reflection mirror 20 has an opening diameter larger than that of the optical deflector 10 (the wedge prism 12). The opening diameter of the first mirror face 21 of the first reflection mirror 20 is defined in such a manner that the entire light beam 6 scanned conically by the optical deflector 10 is reflected by the first mirror face 21 of the first reflection mirror 20.

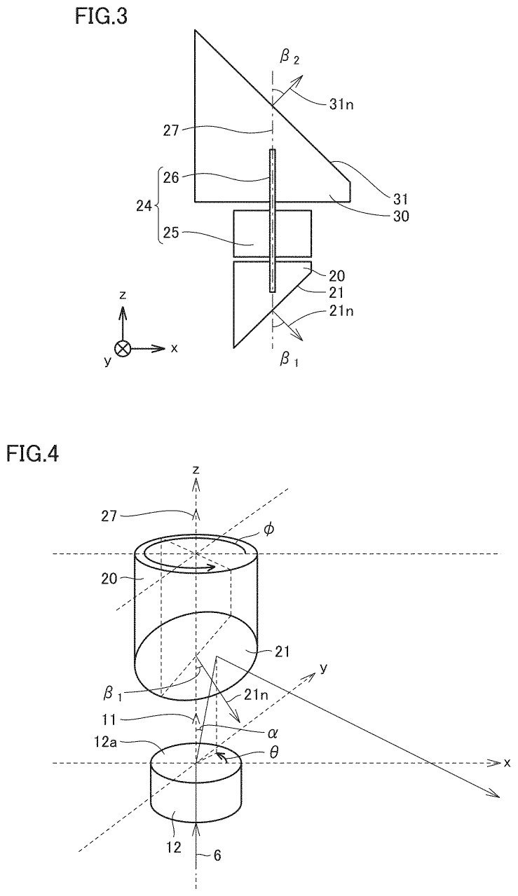

The first reflection mirror 20 is rotatable about a second axis 27. The first mirror face 21 of the first reflection mirror 20 is inclined with respect to the first axis 11 and the second axis 27. The second axis 27 is coaxial with the first axis 11. The second axis 27 extends along the z direction (i.e., the vertical direction). In FIGS. 2 and 3, the first mirror face 21 of the first reflection mirror 20 is inclined with respect to the second axis 27 in the counterclockwise direction. The first mirror face 21 of the first reflection mirror 20 is inclined with respect to the second axis 27 by a first angle β₁. A first unit vector i₁ₘ of the first normal line 21n of the first mirror face 21 is i₁ₘ=(i₁ₘₓ, i_{1my}, i_{1mz})=(cos φ cos β₁, sin φ cos β₁, −sin β₁). As illustrated in FIG. 4, the angle φ is a rotation angle of the first reflection mirror 20 rotated from the front direction (+x direction) of the case 4. When the first unit vector i₁ₘ of a first normal line 21n of the first mirror face 21 projected on an xy plane (i.e., a horizontal plane) is oriented in the front direction (+x direction) of the case 4, the angle φ, i.e., the rotation angle of the first reflection mirror 20 is 0°. In FIG. 2, the angle φ is 0°.

The light beam 6 reflected by the first mirror face 21 has a vector i₂=(i₂ₓ, i_{2y}, i_{2z})=i₁−2(i₁·i₁ₘ)i₁ₘ, wherein i₁·i₁ₘ represents an inner product between the vector i₁ and the first unit vector i₁ₘ. The emission direction of the light beam 6 reflected by the first reflection mirror 20 is determined by rotating the front direction (+x direction) of the case 4 by an angle H given by the expression (1) in the xy plane (for example, the horizontal plane) and then rotating it by an angle V given by the expression (2) to the z direction (for example, the vertical direction) with respect to the xy plane (for example, the horizontal plane).

$$\begin{matrix}Expression 1 & \\ H = {tan}^{- 1} ( \frac{{i}_{2 y}}{{i}_{2 x}} ) & ( 1 ) \\ Expression 2 & \\ V = {tan}^{- 1} ( \frac{{i}_{2 x}}{\sqrt{{{i}_{2 x}}^{2} + {{i}_{2 y}}^{2}}} ) & ( 2 )\end{matrix}$$

The second reflection mirror 30 is configured to reflect the light beam 6 diffusely reflected by an object in the surrounding space of the obstacle detection apparatus 1 toward the light receiver 36.

Specifically, the second reflection mirror 30 may be, for example, a rod mirror. The second reflection mirror 30 may be formed by cutting a cylindrical member obliquely with respect to the axial direction of the cylindrical member so as to form an inclined end face on the cylindrical member, and coating a reflection material on the inclined end face. A second mirror face 31 of the second reflection mirror 30 may be the inclined end face coated with a reflection material. As illustrated in FIGS. 2 and 3, the second reflection mirror 30 is arranged on a distal side from the optical deflector 10 with respect to the first reflection mirror 20. The second mirror face 31 of the second reflection mirror 30 may face the light receiver 36.

The second mirror face 31 of the second reflection mirror 30 is inclined with respect to the second axis 27 in a direction opposite to the first mirror face 21. In FIGS. 2 and 3, the second mirror face 31 of the second reflection mirror 30 is inclined with respect to the second axis 27 in the clockwise direction. The second mirror face 31 of the second reflection mirror 30 is inclined with respect to the second axis 27 by a second angle β₂. When the rotation angle of the second reflection mirror 30 rotated from the front direction (+x direction) of the case 4 is equal to the rotation angle φ of the first reflection mirror 20, the second unit vector i₂ₘ of the second normal line 31n of the second mirror face 31 is i₂ₘ=(i₂ₘₓ, i_{2my}, i_{2mz})=(cos φ cos β₂, sin φ cos β₂, sin β₂).

The first unit vector of the first normal line 21n of the first mirror face 21 projected on a plane (the xy plane, for example, the horizontal plane) perpendicular to the second axis 27 may be substantially parallel to the second unit vector of the second normal line 31n of the second mirror face 31 projected on the same plane (the xy plane). In the present specification, the expression that the first unit vector of the first normal line 21n projected on the plane (the xy plane) is substantially parallel to the second unit vector of the second normal line 31n projected on the same plane (the xy plane) means that the first unit vector of the first normal line 21n projected on the plane (the xy plane) is inclined by 0° or more and 3° or less with respect to the second unit vector of the second normal line 31n projected on the same plane (the xy plane).

Specifically, the first unit vector of the first normal line 21n projected on the plane (the xy plane) may be inclined by 0° or more and 1° or less with respect to the second unit vector of the second normal line 31n projected on the same plane (the xy plane). It is preferable that the first unit vector of the first normal line 21n of the first mirror face 21 projected on the plane (the xy plane) is parallel to the second unit vector of the second normal line 31n of the second mirror face 31 projected on the same plane (the xy plane).

The first angle β₁ between the second axis 27 and the first unit vector of the first normal line 21n of the first mirror face 21 is substantially equal to the second angle β₂ between the second axis 27 and the second unit vector of the second normal line 31n of the second mirror face 31. In the present specification, the expression that the first angle β₁ is substantially equal to the second angle β₂ means that the absolute value of the difference between the first angle β₁ and the second angle β₂ is 3° or less. The absolute value of the difference between the first angle β₁ and the second angle β₂ may be 1° or less. Preferably, the difference between the first angle β₁ and the second angle β₂ is zero, in other words, the first angle β₁ is equal to the second angle β₂.

The second mirror face 31 of the second reflection mirror 30 has an opening diameter (area) larger than that of the first mirror face 21 of the first reflection mirror 20. The opening diameter (area) of the second mirror face 31 of the second reflection mirror 30 may be, for example, twice or more the opening diameter (area) of the first mirror face 21 of the first reflection mirror 20. The opening diameter of the second mirror face 31 of the second reflection mirror 30 is equal to or larger than the opening diameter of the light receiver 36. The second reflection mirror 30 is rotatable about the second axis 27.

The first driving unit 24 is configured to rotate the first reflection mirror 20 and the second reflection mirror 30 about the second axis 27 in synchronization with each other. Therefore, the second reflection mirror 30 may guide the light beam 6 diffusely reflected by the object in the surrounding space of the obstacle detection apparatus 1 to the light receiver 36 with a low optical loss.

Specifically, as illustrated in FIGS. 2 and 3, the first driving unit 24 includes a first motor 25, and a first shaft 26 which is coupled to the first motor 25 and rotatable about the second axis 27. The first driving unit 24 (the first motor 25) is attached to a flat plate 4d of the case 4. The first reflection mirror 20 and the second reflection mirror 30 are connected to the first shaft 26. The first motor 25 is configured to rotate the first shaft 26 about the second axis 27. When the first shaft 26 is rotated by the first motor 25, the first reflection mirror 20 and the second reflection mirror 30 are rotated about the second axis 27 in synchronization with each other. Thus, the first reflection mirror 20 scans the light beam 6 about the second axis 27. The second reflection mirror 30 reflects the light beam 6 diffusely reflected by an object such as an obstacle toward the light receiver 36.

The light receiver 36 is configured to receive the light beam 6 reflected by the second reflection mirror 30. The light receiver 36 may be arranged to face the second mirror face 31 of the second reflection mirror 30. The light receiver 36 may be, for example, a photodiode. The light receiver 36 is fixed to a top plate 4f of the case 4. The condenser lens 35 may be arranged between the second reflection mirror 30 and the light receiver 36. The condenser lens 35 focuses the light beam 6 reflected by the second reflection mirror 30 on the light receiver 36. The condenser lens 35 is attached to a flat plate 4e of the case 4.

The case 4 houses the optical deflector 10, the first reflection mirror 20, the second reflection mirror 30, and the first driving unit 24. The case 4 may further house the light source 5, the collimator lens 8, the condenser lens 35, and the light receiver 36. The case 4 includes a case body and flat plates 4b, 4c, 4d, and 4e. The case body includes a bottom plate 4a, a top plate 4f, and a back plate 4g connecting the bottom plate 4a and the top plate 4f to each other. The flat plates 4b, 4c, 4d and 4e are arranged in a cavity of the case body. The flat plates 4b, 4c, 4d and 4e may be arranged to extend in parallel with the bottom plate 4a and the top plate 4f.

The light source 5 is supported by the bottom plate 4a. The lens holder 9 that holds the collimator lens 8 is supported by the bottom plate 4a. The second driving unit 17 is supported by the flat plate 4b. The wedge prism 12 is supported by the flat plate 4c in such a manner that it is rotatable about the first axis 11. The first driving unit 24 is supported by the flat plate 4d. The first reflection mirror 20 and the second reflection mirror 30 are supported by the flat plate 4d via the first driving unit 24. The first reflection mirror 20 is arranged in a space between the flat plates 4c and 4d. The second reflection mirror 30 is arranged in a space between the flat plate 4d and the flat plate 4e. The condenser lens 35 is supported by the flat plate 4e. The light receiver 36 is supported by the top plate 4f.

The optical deflector 10 is supported by the flat plate 4b and the flat plate 4c, whereas the first driving unit 24 is supported by the flat plate 4d. The optical deflector 10 and the first driving unit 24 are attached to the case 4 independently of each other. In other words, the optical deflector 10 and the first driving unit 24 are attached to the case 4 at different locations.

The case body is provided with a first opening 4p and a second opening 4q. The first opening 4p faces the first mirror face 21 of the first reflection mirror 20. The second opening 4q faces the second mirror face 31 of the second reflection mirror 30. The case 4 may include a first transparent window member 4u which seals the first opening 4p and a second transparent window member 4w which seals the second opening 4q. The first transparent window member 4u and the second transparent window member 4w are transparent to the light beam 6. The light beam 6 reflected by the first reflection mirror 20 passes through the first transparent window member 4u and is emitted to the surrounding space of the obstacle detection apparatus 1. The light beam 6 diffusely reflected by an object such as an obstacle passes through the second transparent window member 4w and is incident on the second reflection mirror 30.

As illustrated in FIG. 5, the obstacle detection apparatus 1 may further include a control unit 40. The control unit 40 is communicatively connected to the optical deflector 10 (the second driving unit 17) and the first driving unit 24 (the first motor 25).

The control unit 40 is configured to control the optical deflector 10 (the second driving unit 17) and the first driving unit 24 (the first motor 25). The control unit 40 controls the optical deflector 10 (the second driving unit 17) in such a manner that the optical deflector 10 scans the light beam 6 conically about the first axis 11 at a first frequency. The control unit 40 controls the first driving unit 24 in such a manner that the first driving unit 24 drives the first reflection mirror 20 and the second reflection mirror 30 to rotate about the second axis 27 at a second frequency. The first frequency is greater than the second frequency. Since the first frequency is different from the second frequency, the difference between the angle θ, which is the rotation angle of the wedge prism 12, and the angle φ, which is the rotation angle of the first reflection mirror 20, varies with time. The first frequency may be an integer multiple of the second frequency.

The control unit 40 may be communicatively connected to the light source 5.

The control unit 40 may be configured to control the light source 5. The control unit 40 may be configured to control, for example, a light emission timing or a light emission rate of the light source 5. The control unit 40 may be communicatively connected to the light receiver 36. The control unit 40 may include an arithmetic unit 41. The arithmetic unit 41 may be, for example, a CPU or a GPU. The control unit 40 receives a signal from the light receiver 36. The computing unit 41 is configured to process this signal so as to calculate the position and shape of an object in the surrounding space of the obstacle detection apparatus 1.

The light beam 6 scanned conically by the optical deflector 10 about the first axis 11 is reflected by the first reflection mirror 20 that rotates about the second axis 27 which is coaxial with the first axis 11. Thus, the light beam 6 may be scanned in three dimensions. The light beam 6 diffusely reflected by an object such as an obstacle is reflected by the second reflection mirror 30 that rotates about the second axis 27, and enters the light receiver 36. Thus, the obstacle detection apparatus 1 may detect the position and shape of an obstacle in the surrounding space of the obstacle detection apparatus 1.

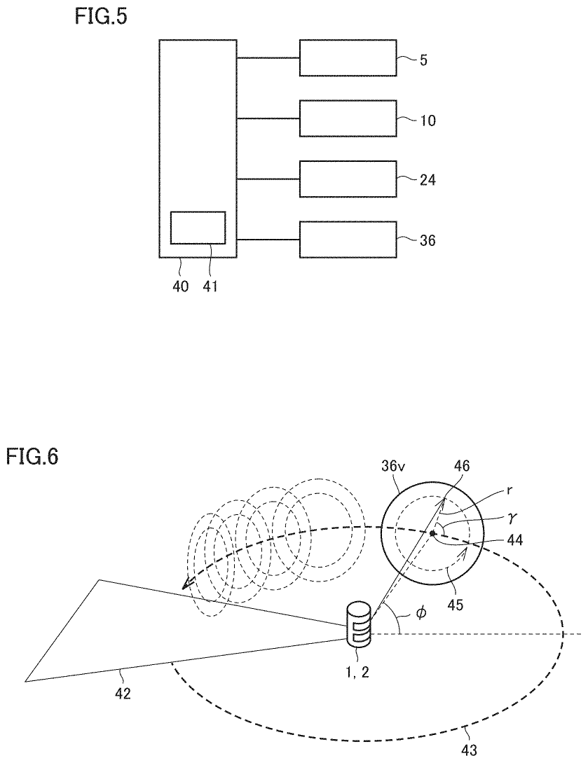

An example operation of the obstacle detection apparatus 1 will be described with reference to FIGS. 6 to 8. In the example of the present embodiment illustrated in FIGS. 6 to 8, the parameters are set as follows. The apex angle 2α at which the light beam 6 is scanned conically by the optical deflector 10 is 16°. The first angle β₁ and the second angle β₂ are both 45°. The first unit vector of the first normal line 21n of the first mirror face 21 projected on the plane (the xy plane) perpendicular to the second axis 27 is parallel to the second unit vector of the second normal line 31n of the second mirror face 31 projected on the same plane (the xy plane). The rotation angle of the second reflection mirror 30 rotated from the front direction (+x direction) of the case 4 and the rotation angle of the first reflection mirror 20 rotated from the front direction (+x direction) of the case 4 are both equal to the angle φ. The z direction is the vertical direction, and the xy plane is the horizontal plane. The first axis 11 and the second axis 27 extend in the z direction (the vertical direction).

As illustrated in FIG. 6, since the first angle β₁ is 45° and the first axis 11 and the second axis 27 extend in the vertical direction (the z direction), the light beam 6 reflected by the first reflection mirror 20 travels in the horizontal direction (the direction along the xy plane). When the rotation angle of the first reflection mirror 20 is equal to the angle φ, the light beam 6 is emitted toward a point 44 on the main circle 43 rotated from the front direction (+x direction) of the case 4 in the horizontal plane (the xy plane) by the angle φ which is equal to the rotation angle of the first reflection mirror 20. In other words, the light beam 6 is emitted in the direction with an azimuth angle of φ from the front direction (+x direction) of the case 4.

The light beam 6 is scanned conically about the first axis 11 by the optical deflector 10. Therefore, the light beam 6 is emitted to a point 46 on a sub-circle 45 centered at the point 44. An angle (elevation angle) γ of a straight line connecting the point 44 and the point 46 with respect to the horizontal plane (the xy plane) is defined by θ−φ+90°. The scanning angle of the light beam 6 in the vertical direction (the z direction) is defined by a product of a half angle (α) of the apex angle 2α at which the light beam 6 is scanned conically and a sine component (sin γ) of the angle (elevation angle) γ of the straight line connecting the point 44 and the point 46 with respect to the horizontal plane (the xy plane). The light beam 6 may be scanned in the vertical direction (the z direction) by differentiating the second frequency from the first frequency so as to vary the difference between the angle θ and the angle φ with time.

For example, when the deflection angle α of the wedge prism 12 is 8° and the wedge prism 12 is in the same orientation (θ−φ=0°) as the first reflection mirror 20 with respect to the front direction (+x direction) of the case 4, the angle (elevation angle) γ is 90° (θ−φ+90°), whereby the light beam 6 is scanned to a point located on a straight line inclined with respect to the horizontal plane (the xy plane) by 8° in the positive vertical direction (+z direction). When the deflection angle α of the wedge prism 12 is 8° and the wedge prism 12 is in the opposite orientation (θ−φ=180°) to the first reflection mirror 20 with respect to the front direction (+x direction) of the case 4, the angle (elevation angle) γ is 270° (=θ−φ+90°, whereby the light beam 6 is scanned to a point located on a straight line inclined with respect to the horizontal plane (the xy plane) by 8° in the negative vertical direction (−z direction).

Further, by rotating the first reflection mirror 20 about the second axis 27 which is the vertical axis (the z axis), the sub-circle 45 on which the light beam 6 is scanned by the optical deflector 10 may be scanned in a wide angle in the horizontal plane (the xy plane) except for a blind spot 42 of the case 4. While the light beam 6 is being scanned along the sub-circle 45 at a first frequency, the light beam 6 is scanned around the second axis 27, which is the vertical axis (the z axis), at a second frequency smaller than the first frequency. Thus, it is possible for the obstacle detection apparatus 1 to scan the light beam 6 in three dimensions, which make it possible to detect the position and shape of an object in the surrounding space of the obstacle detection apparatus 1.

Since the rotation angle of the second reflection mirror 30 rotated from the front direction (+x direction) of the case 4 is equal to the rotation angle of the first reflection mirror 20 rotated from the front direction (+x direction) of the case 4 and the second angle β₂ is equal to the first angle β₁, during the scanning of the light beam 6, the center of a field of view 36v of the light receiver 36 coincides with the point 44 which is the center of the sub-circle 45 scanned by the light beam 6. During the scanning of the light beam 6, the field of view 36v of the light receiver 36 moves in the horizontal plane (the xy plane) in synchronization with the sub-circle 45 where the light beam 6 is located, and continues to cover the sub-circle 45 where the light beam 6 is located. Whereby, during the scanning of the light beam 6, it is possible for the light receiver 36 to continuously receive the light beam 6 diffusely reflected by an object in the surrounding space of the obstacle detection apparatus 1.

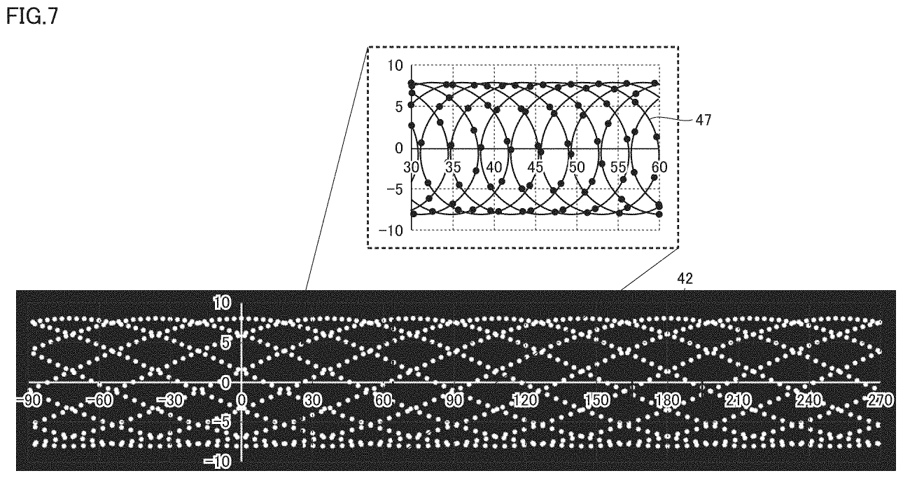

In an example of the present embodiment illustrated in FIG. 7, the rotation speed of the wedge prism 12 is 6000 rpm, the rotation speed of the first reflection mirror 20 is 60 rpm, and the light emission rate of the light source 5 is 1 kHz. Since the rotation speed of the wedge prism 12 is 6000 rpm, the optical deflector 10 scans the light beam 6 conically about the first axis 11 at a first frequency of 100 Hz. Since the rotation speed of the first reflection mirror 20 is 60 rpm, the first reflection mirror 20 rotates about the second axis 27 at a second frequency of 1 Hz. Since the light beam 6 is scanned conically by the optical deflector 10 (the rotation of the wedge prism 12), the trajectory 47 of the detection point (see FIG. 7) becomes a circle. Due to the rotation of the first reflection mirror 20 and the second reflection mirror 30, the trajectory 47 is scanned in a wide angle (for example, over a range of 330°) in the horizontal plane (the xy plane) except for the blind spot 42 of the case 4 (for example, 30°).

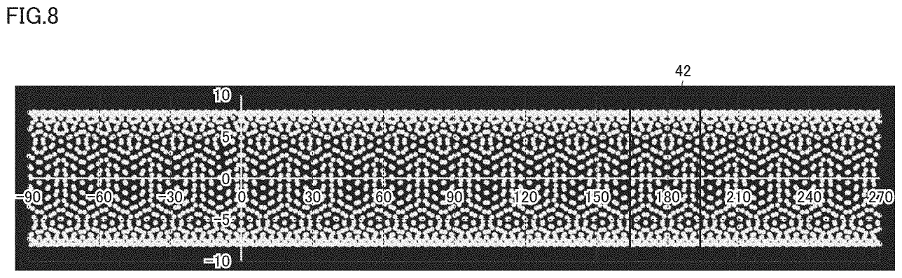

An example of the present embodiment illustrated in FIG. 8 is different from the example of the present embodiment illustrated in FIG. 7 in the light emission rate of the light source 5. In an example of the present embodiment illustrated in FIG. 8, the light emission rate of the light source 5 is 4 kHz. The light emission rate of the light source 5 in the example illustrated in FIG. 8 is higher than that in the example illustrated in FIG. 7. Therefore, it is possible for the example illustrated in FIG. 8 to scan more locations than the example illustrated in FIG. 7, which makes it possible to detect an object at more detection points. In an example of the present embodiment illustrated in FIG. 8, the object may be detected at a higher resolution.

Effects of the obstacle detection apparatus 1 according to the present embodiment will be described.

The obstacle detection apparatus 1 according to the present embodiment mainly includes an optical deflector 10, a first reflection mirror 20, a second reflection mirror 30, and a light receiver 36. The optical deflector 10 is configured to scan at least one light beam 6 conically about the first axis 11. The first reflection mirror 20 is arranged to face the optical deflector 10 and rotatable about the second axis 27. The first reflection mirror 20 is configured to reflect at least one light beam 6 toward the surrounding space of the obstacle detection apparatus 1. The first mirror face 21 of the first reflection mirror 20 is inclined with respect to the first axis 11 and the second axis 27. The second reflection mirror 30 is arranged on a distal side from the optical deflector 10 with respect to the first reflection mirror 20 and is rotatable about the second axis 27. The second mirror face 31 of the second reflection mirror 30 is configured to reflect at least one light beam 6 diffusely reflected by an object in the surrounding space of the obstacle detection apparatus 1 toward the light receiver 36. The second mirror face 31 of the second reflection mirror 30 is inclined with respect to the second axis 27 in a direction opposite to the first mirror face 21. The light receiver 36 is configured to receive at least one light beam 6 reflected by the second reflection mirror 30. The first reflection mirror 20 and the second reflection mirror 30 are driven to rotate about the second axis 27 in synchronization with each other. The second axis 27 is coaxial with the first axis 11.

Since the reflection of the light beam 6 diffusely reflected by the object in the surrounding space of the obstacle detection apparatus 1 toward the light receiver 6 is performed by the second reflection mirror 30 different from the first reflection mirror 20, it is possible to make the first reflection mirror 20 smaller in size. Since the second axis 27 is coaxial with the first axis 11, even if the first reflection mirror 20 is made smaller in size, it is possible for the first reflection mirror 20 to reflect the light beam 6 scanned conically about the first axis 11 by the optical deflector 10 without additional optical loss. The first reflection mirror 20 may be made smaller in size. Thus, it is possible to make the obstacle detection apparatus of the present invention smaller in size.

The obstacle detection apparatus 1 can detect the position and shape of an object in the surrounding space of the obstacle detection apparatus 1 by using the first reflection mirror 20 and the second reflection mirror 30 to scan the light beam 6 in three dimensions. Since the second axis 27 is coaxial with the first axis 11, it is possible to stabilize the scanning direction of the light beam 6 reflected by the first reflection mirror 20. The obstacle detection apparatus 1 can detect the position and shape of an object in the surrounding space of the obstacle detection apparatus 1 with high accuracy. Since the first reflection mirror 20 and the second reflection mirror 30 are rotated about the second axis 27 in synchronization with each other, it is possible for the second reflection mirror 30 to guide the light beam 6 diffusely reflected by the object in the surrounding space of the obstacle detection apparatus 1 to the light receiver 36 with a low optical loss. Thus, the obstacle detection apparatus 1 can detect the position and shape of the object in the surrounding space of the obstacle detection apparatus 1 with higher accuracy. Thereby, it is possible to extend the detection range of the obstacle detection apparatus 1.

The obstacle detection apparatus 1 according to the present embodiment further includes a first driving unit 24 and a case 4. The first driving unit 24 is configured to rotate the first reflection mirror 20 and the second reflection mirror 30 about the second axis 27 in synchronization with each other. The case 4 houses the optical deflector 10, the first reflection mirror 20, the second reflection mirror 30, and the first driving unit 24. The optical deflector 10 and the first driving unit 24 are attached to the case 4 independently of each other. The first driving unit 24 includes a first motor 25, and a shaft (first shaft 26) which is coupled to the first motor 25 and rotatable about a second axis 27. The first reflection mirror 20 and the second reflection mirror 30 are fixed to the shaft (the first shaft 26). The first motor 25 is configured to rotate the shaft (the first shaft 26) about the second axis 27.

Since the optical deflector 10 and the first driving unit 24 configured to rotate the first reflection mirror 20 and the second reflection mirror 30 are attached to the case 4 independently of each other, it is possible to make the optical deflector 10 and the first driving unit 24 smaller in size, which make it possible to make the obstacle detection apparatus 1 smaller in size. Further, since the expensive non-contact power supply unit disclosed in PTL1 is not required in the obstacle detection apparatus 1, it is possible to reduce the cost of the obstacle detection apparatus 1.

In the obstacle detection apparatus 1 of the present embodiment, the first unit vector of the first normal line 21n of the first mirror face 21 projected on the plane perpendicular to the second axis 27 is substantially parallel to the second unit vector of the second normal line 31n of the second mirror face 31 projected on the same plane. Therefore, it is possible for the light beam 6 which is emitted from the first reflection mirror 20 and diffusely reflected by the object to enter the second reflection mirror 30 with a lower optical loss, which makes it possible to extend the detection range of the obstacle detection apparatus 1.

In the obstacle detection apparatus 1 of the present embodiment, the first angle 131 between the second axis 27 and the first unit vector of the first normal line 21n of the first mirror face 21 is substantially equal to the second angle β₂ between the second axis 27 and the second unit vector of the second normal line 31n of the second mirror face 31. Therefore, it is possible for the light beam 6 which is emitted from the first reflection mirror 20 and diffusely reflected by the object to enter the second reflection mirror 30 with a lower optical loss, which makes it possible to extend the detection range of the obstacle detection apparatus 1.

The second mirror face 31 has an opening diameter (area) larger than that of the first mirror face 21. Therefore, it is possible for the light beam 6 which is emitted from the first reflection mirror 20 and diffusely reflected by the object to enter the second reflection mirror 30 with a lower optical loss, which makes it possible to extend the detection range of the obstacle detection apparatus 1.

In the obstacle detection apparatus 1 of the present embodiment, the optical deflector 10 includes a wedge prism 12 rotatable about the first axis 11, and a second driving unit 17 configured to rotate the wedge prism 12 about the first axis 11. Therefore, the obstacle detection apparatus 1 may be made smaller in size.

The obstacle detection apparatus 1 according to the present embodiment further includes a control unit 40 configured to control the optical deflector 10 and the first driving unit 24. The control unit 40 controls the optical deflector 10 in such a manner that the optical deflector 10 scans at least one light beam 6 conically about the first axis 11 at a first frequency. The control unit 40 controls the first driving unit 24 in such a manner that the first driving unit 24 rotates the first reflection mirror 20 and the second reflection mirror 30 about the second axis 27 at a second frequency. The first frequency is greater than the second frequency. Therefore, the obstacle detection apparatus 1 may be made smaller in size.

In the obstacle detection apparatus 1 of the present embodiment, the optical deflector 10 has an opening diameter smaller than that of the first mirror face 21 of the first reflection mirror 20 and the second mirror face 31 of the second reflection mirror 30. The optical deflector 10 having a relatively small size is driven at a high speed at the first frequency, while the first reflection mirror 20 and the second reflection mirror 30 having a relatively large size are driven at a low speed at the second frequency. Therefore, it is possible to reduce the driving force required to drive the optical deflector 10, the first reflection mirror 20 and the second reflection mirror 30, which makes it possible to reduce the power consumption of the obstacle detection apparatus 1. Therefore, it is possible to prevent the obstacle detection apparatus 1 from being degraded and damaged mechanically, which makes it possible to increase the service life of the obstacle detection apparatus 1.

### Second Embodiment

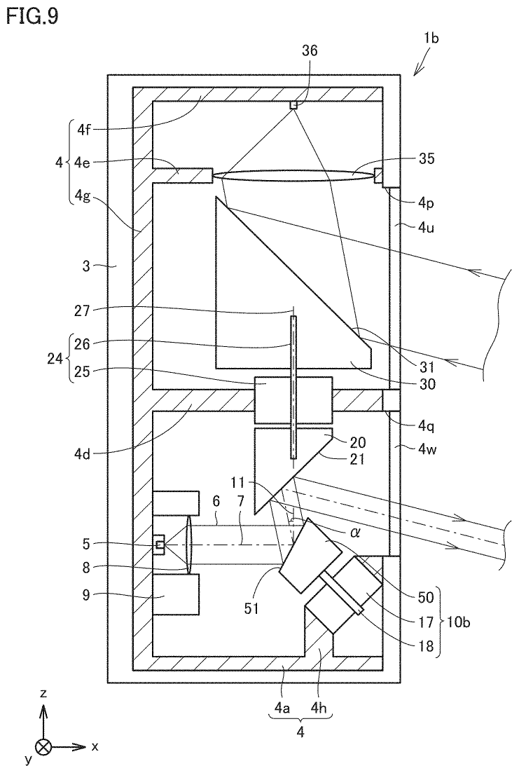

An obstacle detection apparatus 1b according to a second embodiment will be described with reference to FIG. 9. The obstacle detection apparatus 1b of the present embodiment has the same configuration as the obstacle detection apparatus 1 of the first embodiment, but is mainly different in the configuration of the optical deflector 10b and the arrangement of the light source 5 and the collimator lens 8.

In the present embodiment, the optical deflector 10b includes a rotatable optical deflection mirror 50 and a second driving unit 17 configured to rotate the optical deflection mirror 50. The rotation axis of the optical deflection mirror 50 extends in parallel with a line bisecting the angle between the optical axis 7 of the light beam 6 incident on the optical deflector 10b and the first axis 11. The normal line of the third mirror face 51 of the optical deflection mirror 50 is inclined with respect to the rotation axis of the optical deflection mirror 50 by an angle of α/4, for example.

The second driving unit 17 is, for example, a second motor. The second drive section 17 is supported by a support member 4h of the case 4. The second drive unit 17 is configured to rotate the second shaft 18. The second shaft 18 is coupled to the optical deflection mirror 50 and the second driving unit 17. The second shaft 18 extends in parallel with the rotation axis of the optical deflection mirror 50. When the second shaft 18 is rotated by the second driving unit 17, the optical deflection mirror 50 rotates accordingly. Thus, the optical deflection mirror 50 scans the light beam 6 conically about the first axis 11 with an apex angle 2α.

The light source 5 and the collimator lens 8 are supported by the back plate 4g of the case 4. The lens holder 9 that holds the collimator lens 8 is fixed to the back plate of the case 4. The light source 5 emits the light beam 6 in the +x direction (for example, the horizontal direction).

In addition to the effects of the obstacle detection apparatus 1 of the first embodiment, the obstacle detection apparatus 1b of the present embodiment has the following effects.

In the present embodiment, the optical deflector 10b includes a rotatable optical deflection mirror 50 and a second driving unit 17 configured to rotate the optical deflection mirror 50. Thus, the power transmission members such as the bearing 14, the first gear 15 and the second gear 16 (see FIG. 2) are not required. Therefore, the obstacle detection apparatus 1b is made smaller in size and higher in reliability.

### Third Embodiment

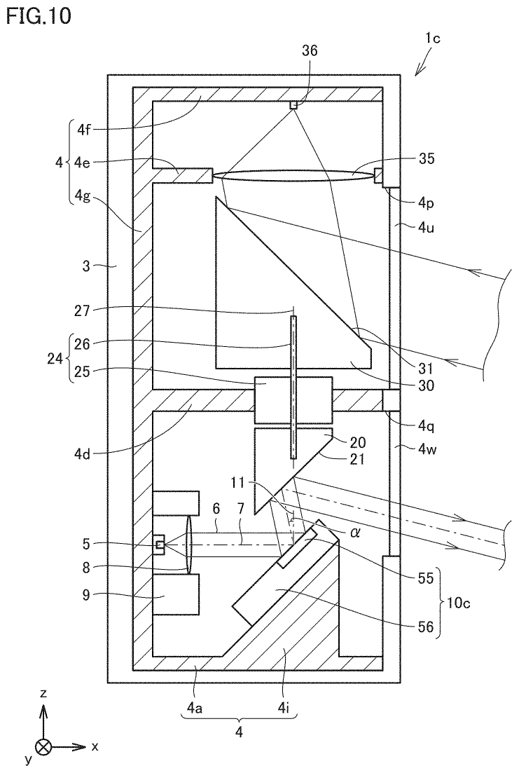

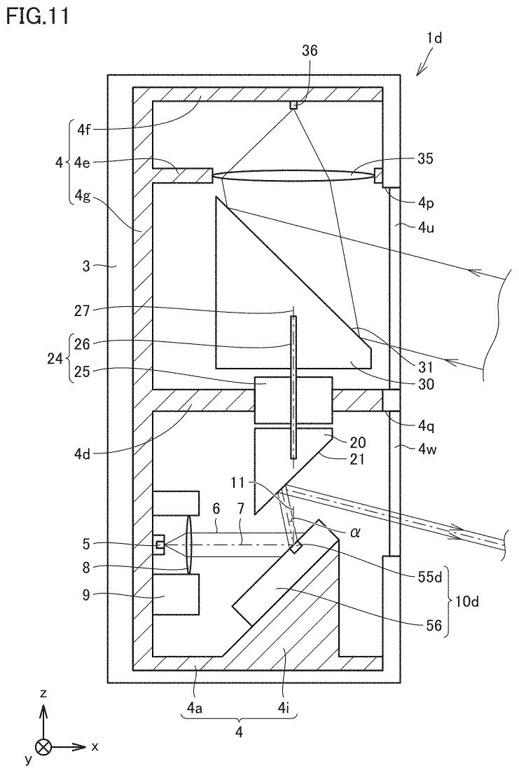

An obstacle detection apparatus 1c according to a third embodiment will be described with reference to FIG. 10. The obstacle detection apparatus 1c according to the present embodiment has the same configuration and the same effects as the obstacle detection apparatus 1b according to the second embodiment, but is mainly different in the following points.

In the present embodiment, the optical deflector 10c includes a MEMS mirror member 55. The optical deflector 10c further includes a support member 56 that supports the MEMS mirror member 55. The support member 56 is fixed to an inclined surface of the support member 4i protruding from the bottom plate 4a of the case 4.

In the present embodiment, the number of movable members having a larger size (for example, the rotatable optical deflection mirror 50, the second motor such as the second drive unit 17 (see FIG. 9)) is smaller than that in the second embodiment. Therefore, the obstacle detection apparatus 1c is made smaller in size and higher in reliability. In addition, the MEMS mirror member 55 may operate at a higher speed than the rotatable optical deflection mirror 50 of the second embodiment (see FIG. 9). Therefore, it is possible for the obstacle detection apparatus 1c to scan the light beam 6 at a higher speed, which makes it possible to detect the position and shape of an object at a higher frame rate. If the frame rate of the obstacle detection apparatus 1c is kept constant, the obstacle detection apparatus 1c may detect the object at a higher resolution.

In the present specification, the frame rate is defined as a reciprocal of the time between a time when the light beam 6 is scanned in the scan starting direction and a time when the light beam 6 is scanned again in the scan starting direction. In the present embodiment, the first frequency, which is a frequency at which the optical deflector 10 scans the light beam 6 conically about the first axis 11, is an integer multiple of the second frequency, which is a frequency at which the first reflection mirror 20 and the second reflection mirror 30 are rotated about the second axis 27, and the frame rate is defined by the second frequency.

### Fourth Embodiment

An obstacle detection apparatus 1d according to a fourth embodiment will be described with reference to FIG. 11. The obstacle detection apparatus 1d according to the present embodiment has the same configuration and the same effects as the obstacle detection apparatus 1c according to the third embodiment, but is mainly different in the configuration of the optical deflector 10d.

In the present embodiment, the opening diameter (size) of the MEMS mirror member 55d in the optical deflector 10d is smaller than the diameter of at least one light beam 6. The MEMS mirror member 55d reflects a part of the light beam 6 incident on the MEMS mirror member 55d to the first reflection mirror 20. The MEMS mirror member 55d, the first reflection mirror 20, and the second reflection mirror 30 of the present embodiment may be made smaller than the MEMS mirror member 55, the first reflection mirror 20, and the second reflection mirror 30 of the third embodiment, which makes it possible to make the obstacle detection apparatus 1d smaller in size.

### Fifth Embodiment

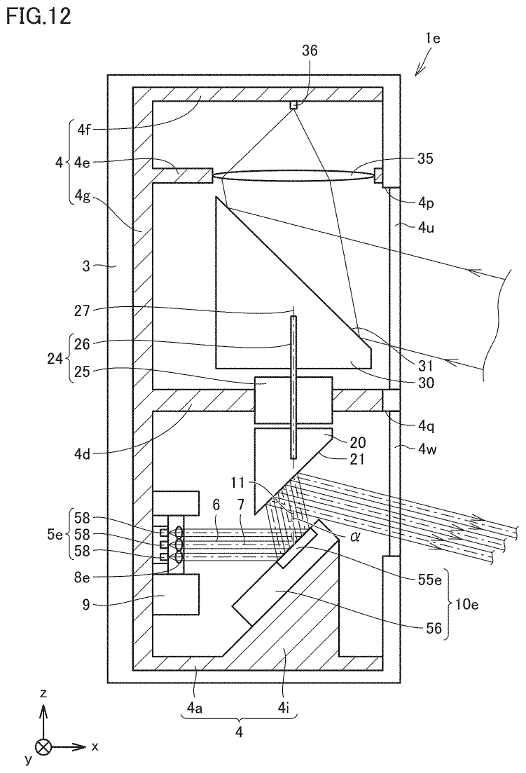

An obstacle detection apparatus 1e according to a fifth embodiment will be described with reference to FIG. 12. The obstacle detection apparatus 1e of the present embodiment has the same configuration as the obstacle detection apparatus 1c of the third embodiment, but is mainly different in the following points.

In the present embodiment, at least one light beam 6 is a plurality of light beams 6. The light source 5e is configured to emit a plurality of light beams 6. The light source 5e includes, for example, a plurality of light emitting units 58. The light source 5e is, for example, a vertical cavity surface emitting laser (VCSEL) array. The collimator lens 8 is a collimator lens array. The collimator lens array collimates each of the plurality of light beams 6. The MEMS mirror member 55e in the optical deflector 10e includes a plurality of MEMS mirrors. Each of the plurality of MEMS mirrors is configured to scan each of the plurality of light beams 6 conically about the first axis 11.

The control unit 40 controls the optical deflector 10e (the plurality of MEMS mirrors) such that the optical deflector 10e (the plurality of MEMS mirrors) scans the plurality of light beams 6 conically about the first axis 11 at the first frequency. The control unit 40 controls the light source 5e such that the light emission timings of the plurality of light emitting units 58 are different from each other. Therefore, the timings at which the plurality of light beams 6 enter the plurality of MEMS mirrors are different from each other.

In addition to the effects of the obstacle detection apparatus 1c of the third embodiment, the obstacle detection apparatus 1e of the present embodiment has the following effects.

In the obstacle detection apparatus 1e of the present embodiment, at least one light beam 6 is a plurality of light beams 6. The MEMS mirror member 55e includes a plurality of MEMS mirrors, each of which is configured to scan each of the plurality of light beams 6 conically about the first axis 11. The timings at which the plurality of light beams 6 enter the plurality of MEMS mirrors are different from each other. Therefore, the plurality of light beams 6 are scanned at mutually different points, which makes it possible for the obstacle detection apparatus 1e to detect an object at a higher resolution.

### Sixth Embodiment

An obstacle detection apparatus 1 according to a sixth embodiment will be described with reference to FIGS. 1 to 6 and 13. The obstacle detection apparatus 1 of the present embodiment has the same configuration as the obstacle detection apparatus 1 of the first embodiment, but is mainly different in the following points.

In the present embodiment, the control unit 40 controls the optical deflector 10 such that the optical deflector 10 scans at least one light beam 6 conically about the first axis 11 at a first frequency. The control unit 40 controls the first driving unit 24 such that the first driving unit 24 rotates the first reflection mirror 20 and the second reflection mirror 30 about the second axis 27 at a second frequency. The first frequency is a non-integer multiple of the second frequency.

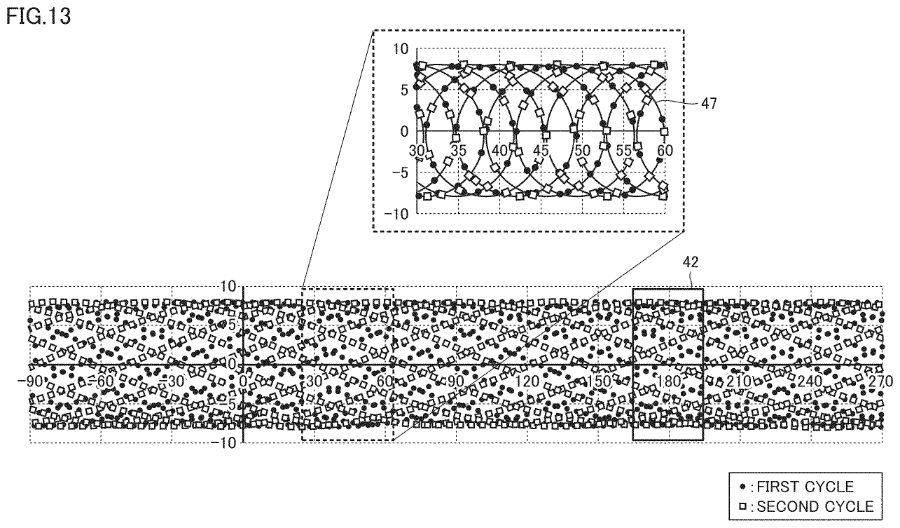

An example operation of the present embodiment will be described with reference to FIG. 13. In the example of the present embodiment, the rotation speed of the wedge prism 12 is 6003 rpm, the rotation speed of the first reflection mirror 20 is 60 rpm, and the light emission rate of the light source 5 is 1 kHz. Since the rotation speed of the wedge prism 12 is 6003 rpm, the optical deflector 10 scans the light beam 6 conically about the first axis 11 at a first frequency of 100.05 Hz. Since the rotation speed of the first reflection mirror 20 is 60 rpm, the first reflection mirror 20 rotates about the second axis 27 at a second frequency of 1 Hz. The first frequency is a non-integer multiple of the second frequency. As illustrated in FIG. 13, each time when the first reflection mirror 20 and the second reflection mirror 30 rotate, the position of the detection point is shifted slightly. Since the light beam 6 is scanned at a higher density, the object may be detected at a higher resolution.

In addition to the effects of the obstacle detection apparatus 1 of the first embodiment, the obstacle detection apparatus 1 of the present embodiment has the following effects.

In the obstacle detection apparatus 1 of the present embodiment, the control unit 40 controls the optical deflector 10 such that the optical deflector 10 scans at least one light beam 6 conically about the first axis 11 at the first frequency. The control unit 40 controls the first driving unit 24 such that the first driving unit 24 rotates the first reflection mirror 20 and the second reflection mirror 30 about the second axis 27 at the second frequency. The first frequency is a non-integer multiple of the second frequency. Therefore, each time when the first reflection mirror 20 and the second reflection mirror 30 rotate, the position of the detection point is shifted slightly. Therefore, it is possible for the obstacle detection apparatus 1 to detect an object at a higher resolution.

It should be understood that the first to sixth embodiments disclosed herein are illustrative and non-restrictive in all respects. At least two of the first to sixth embodiments disclosed herein may be combined unless they are inconsistent to each other. The scope of the present invention is defined by the terms of the claims rather than the description of the embodiments above and is intended to include any modifications within the scope and meaning equivalent to the terms of the claims.

### REFERENCE SIGNS LIST

1, 1b, 1c, 1d, 1e: obstacle detection apparatus; 4: case; 4a: bottom plate; 4b, 4c, 4d, 4e: flat plate; 4f: top plate; 4g: back plate; 4h, 4i: support member; 4p: first opening; 4q: second opening; 4u: first transparent window member; 4w: second transparent window member; 5, 5e: light source; 6: light beam; 7: optical axis; 8: collimator lens; 9: lens holder; 10, 10b, 10c, 10d, 10e: optical deflector; 11: first axis; 12: wedge prism; 12a: top face; 13: prism holder; 14: bearing; 15: first gear; 16: second gear; 17: second driving unit; 18: second shaft; 20: first reflection mirror; 21: first mirror face; 21n: first normal line; 24: first driving unit; 25: first motor; 26: first shaft; 27: second axis; 30: second reflection mirror; 31: second mirror face; 31n: second normal line; 35: condenser lens; 36: light receiver; 36v: field of view; 40: control unit; 41: arithmetic unit; 42: blind spot; 43: main circle; 44: point; 46: point; 45: sub-circle; 47: trajectory; 50: optical deflection mirror; 51: third mirror face; 55, 55d, 55e: mirror member; 56: support member; 58: light emitting unit

1. An obstacle detection apparatus comprising:
an optical deflector configured to scan at least one light beam conically about a first axis;
a first reflection mirror arranged to face the optical deflector and rotatable about a second axis;
a second reflection mirror arranged on a distal side from the optical deflector with respect to the first reflection mirror and rotatable about the second axis;
a light receiver, and
a case housing the optical deflector, the first reflection mirror, and the second reflection mirror,
the first reflection mirror and the second reflection mirror being driven to rotate about the second axis in synchronization with each other,
the first reflection mirror being configured to reflect the at least one light beam toward a surrounding space of the obstacle detection apparatus, a first mirror face of the first reflection mirror being inclined with respect to the first axis and the second axis,
the second reflection mirror being configured to reflect the at least one light beam diffusely reflected by an object in the surrounding space of the obstacle detection apparatus toward the light receiver, a second mirror face of the second reflection mirror being inclined with respect to the second axis in a direction opposite to the first mirror face and having an opening diameter larger than that of the first mirror face, and
the light receiver being configured to receive the at least one light beam reflected by the second reflection mirror, and
the optical deflector being not arranged between the second reflection mirror and the light receiver,
the second axis being coaxial with the first axis,
the case including a bottom plate and a support member protruding from the bottom plate to the inside of the case,
the optical deflector including a MEMS mirror member and being fixed to an inclined surface of the support member.

2.-8. (canceled)

9. The obstacle detection apparatus according to claim 1, wherein
an opening diameter of the MEMS mirror member is smaller than a diameter of the at least one light beam.

10. The obstacle detection apparatus according to claim 1, wherein
the at least one light beam is a plurality of light beams,
the MEMS mirror member includes a plurality of MEMS mirrors, each of which is configured to scan each of the plurality of light beams conically about the first axis, and
timings at which the plurality of light beams are incident on the plurality of MEMS mirrors are different from each other.

11. The obstacle detection apparatus according to claim 1 further comprises:
a first driving unit configured to rotate the first reflection mirror and the second reflection mirror about the second axis in synchronization with each other; and
a controller configured to control the optical deflector and the first driving unit, wherein
the controller controls the optical deflector in such a manner that the optical deflector scans the at least one light beam conically about the first axis at a first frequency,
the controller controls the first driving unit in such a manner that the first driving unit rotates the first reflection mirror and the second reflection mirror about the second axis at a second frequency, and
the first frequency is greater than the second frequency.

12. The obstacle detection apparatus according to claim 1, wherein
the optical deflector has an opening diameter smaller than that of the first mirror face and that of the second mirror face.

13. The obstacle detection apparatus according to claim 11, wherein
the first frequency is a non-integer multiple of the second frequency.

14. The obstacle detection apparatus according to claim 1 further comprises a light source housed in the case, wherein
the light source emits the at least one light beam traveling in a direction perpendicular to the first axis to the optical deflector.
